(19) United States
(12) Patent Application Publication
(10) Pub. No.: US 2022/0168892 A1
(43) Pub. Date: Jun. 2, 2022

(54) METHOD FOR SUPPORTING CREATION OF PROGRAM, PROGRAM CREATION SUPPORTING APPARATUS AND STORAGE MEDIUM

(71) Applicant: Seiko Epson Corporation, Tokyo (JP)

(72) Inventors: Hiroki ADACHI, Yokohama (JP); Kaoru TAKEUCHI, Azumino (JP); Hirofumi KINOSHITA, Matsumoto (JP)

(21) Appl. No.: 17/536,237

(22) Filed: Nov. 29, 2021

(30) Foreign Application Priority Data
Nov. 30, 2020 (JP) 2020-198135

(51) Int. Cl. B25J 9/16; B25J 13/08

(52) U.S. Cl. CPC B25J 9/1664; B25J 13/085

(57) ABSTRACT

A method for supporting creation of a program for supporting creation of a program for a robot that performs work on an object by force control for controlling a force acting on the object to be a target force, includes displaying a mark having an aspect indicating the target force on a display device, changing the aspect of the mark according to an operation on an input device by a user, and presenting a parameter in the force control corresponding to the aspect of the mark to the user.

The present application is based on, and claims priority from JP Application Serial Number 2020-198135, filed Nov. 30, 2020, the disclosure of which is hereby incorporated by reference herein in its entirety.

### BACKGROUND

### 1. Technical Field

The present disclosure relates to a method for supporting creation of a program, a program creation supporting apparatus, a program creation supporting program, and a storage medium.

### 2. Related Art

JP-A-2014-233814 discloses a robot teaching assisting apparatus that adjusts a parameter on force control of a robot based on a designated value and a measurement value of a force sensor and generates a teaching operation window containing guidance information on input of the parameter.

However, in the technique disclosed in JP-A-2014-233814, it may be difficult to grasp a relationship between the parameter on force control and a target force in the force control.

### SUMMARY

An aspect of the present disclosure is directed to a method for supporting creation of a program for supporting creation of a program for a robot that performs work on an object by force control for controlling a force acting on the object to be a target force, including displaying a mark having an aspect indicating the target force on a display device, changing the aspect of the mark according to an operation on an input device by a user, and presenting a parameter in the force control corresponding to the aspect of the mark to the user.

Another aspect of the present disclosure is directed to a program creation supporting apparatus supporting creation of a program for a robot that performs work on an object by force control for controlling a force acting on the object to be a target force, including a display device displaying a mark having an aspect indicating the target force, an input device detecting an operation by a user, and a control circuit changing the aspect of the mark according to the operation, and presenting a parameter in the force control corresponding to the aspect of the mark to the user.

Another aspect of the present disclosure is directed to a non-transitory computer-readable storage medium storing a program creation supporting program for supporting creation of a program for a robot that performs work on an object by force control controlling a force acting on the object to be a target force, the program controlling a computer to execute processing including: displaying a mark having an aspect indicating the target force on a display device, changing the aspect of the mark according to an operation on an input device by a user, and presenting a parameter in the force control corresponding to the aspect of the mark to the user.

Another aspect of the present disclosure is directed to a storage medium readable by the computer, storing the above described program creation supporting program.

### BRIEF DESCRIPTION OF THE DRAWINGS

FIG. 1 is a block diagram for explanation of a basic configuration of a program creation supporting apparatus according to an embodiment.

FIG. 2 is a diagram for explanation of an example of a simulation window in a direction adjustment mode.

FIG. 3 is a diagram for explanation of an example of an adjustment panel.

FIG. 4 is a diagram for explanation of a method for determining a direction of a target force.

FIG. 5 is a diagram for explanation of an example of the simulation window in a force adjustment mode.

FIG. 6 is a diagram for explanation of an example of the simulation window in a torque adjustment mode.

FIG. 7 is a diagram for explanation of an example of a color bar.

FIG. 8 is a diagram for explanation of an example of the simulation window in a force impedance parameter adjustment mode.

FIG. 9 is a diagram for explanation of an example of the simulation window in a torque impedance parameter adjustment mode.

FIG. 10 is a diagram for explanation of an example of a parameter window.

FIG. 11 is a flowchart for explanation of an example of a method for supporting creation of a program.

FIG. 12 is a diagram for explanation of another example of the adjustment panel.

### DESCRIPTION OF EXEMPLARY EMBODIMENTS

As below, an embodiment of the present disclosure will be explained with reference to the drawings. In the drawings, the same or similar elements may respectively have the same or similar signs and the overlapping explanation may be omitted.

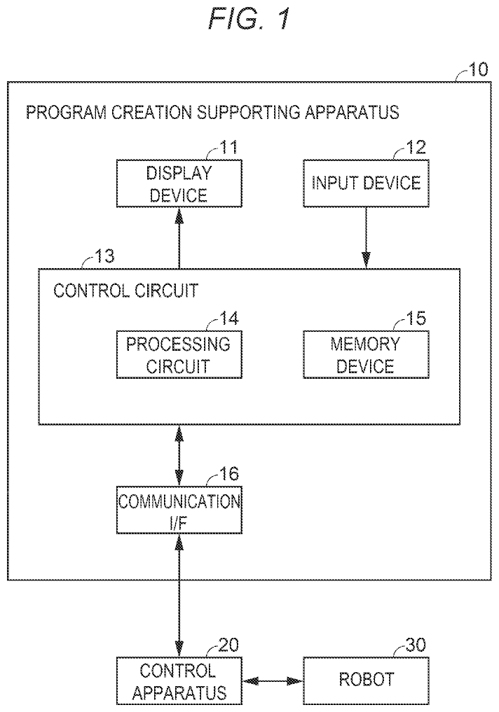

As shown in FIG. 1, a robot system according to the embodiment includes a program creation supporting apparatus 10, a control apparatus 20, and a robot 30. The robot 30 performs work on an object by force control for controlling a force acting on the object to be a target force. The control apparatus 20 controls the robot 30 to perform work on the object according to a program. Here, the program refers to a task program for the robot 30 to perform motion and an auxiliary function for execution of an intended task. The program creation supporting apparatus 10 supports creation of a program for the robot 30.

The robot 30 is, for example, an articulated robot having a six-axis arm moving at six degrees of freedom. The robot 30 includes a base, a manipulator supported by the base, an end effector attached to a mechanical interface of the manipulator, and a force sensor. The manipulator of the robot 30 includes a plurality of actuators driving respective joints of the manipulator and a plurality of encoders detecting rotation angles of the respective joints. The force sensor of the robot 30 detects the force acting on the object via the end effector.

The control apparatus 20 executes the program to control the manipulator and the end effector of the robot 30 and controls the robot 30 to perform work on the object. A signal corresponding to the force acting on the object is input from the force sensor of the robot 30 to the control apparatus 20. The control apparatus 20 performs force control on the robot 30 so that the force acting on the object may be a target force defined by the program. In the embodiment, the force may refer to a load, i.e., a force and torque. A force of a translational component may be referred to as “translational force” for distinction from the load.

Further, the control apparatus 20 controls the robot 30 so that a pose obtained from the encoders of the robot 30 may be a target pose defined by the program. The pose refers to, for example, a position and an attitude of a tool center point (TCP). The TCP is a reference for the position of the end effector of the robot 30.

The program creation supporting apparatus 10 includes a display device 11, an input device 12, a control circuit 13, and a communication interface (I/F) 16. The program creation supporting apparatus 10 can be configured using various general-purpose computers. The respective hardware of the program creation supporting apparatus 10 may be shared with the control apparatus 20. The display device 11 displays an image according to control by the control circuit 13. As the display device 11, for example, a display device such as a liquid crystal display or an organic light emitting diode display may be employed.

The input device 12 detects an operation by a user and outputs a signal according to the operation by the user to the control circuit 13. As the input device 12, for example, various input devices including a pointing device such as a mouse, a keyboard, a push button, and a touch sensor may be employed. As the display device 11 and the input device 12 integrally formed with each other, a touch-panel display may be employed.

The control circuit 13 includes a processing circuit 14 and a memory device 15. The processing circuit 14 forms a processing unit of a computer that processes calculations necessary for operation of the program creation supporting apparatus 10. The processing circuit 14 realizes various functions of the program creation supporting apparatus 10 described in the embodiment by executing, for example, a program creation supporting program stored in the memory device 15. As a processing unit forming at least a part of the processing circuit 14, various arithmetic logic circuits including, for example, a central processing unit (CPU), a digital signal processor (DSP), a programmable logic device (PLD), and an application specific integrated circuit (ASIC) may be employed. The processing circuit 14 may be formed using integrated hardware or a plurality of separate pieces of hardware.

The memory device 15 includes a computer-readable storage medium that stores the program creation supporting program representing a series of processing necessary for operation of the program creation supporting apparatus 10 and various kinds of data. As the storage medium, for example, a semiconductor memory or various disk media may be employed. The storage medium is not limited to a nonvolatile auxiliary storage device, but may include a volatile main storage device such as a register or a cache memory. At least a part of the storage medium may be formed using a part of the processing circuit 14. The memory device 15 may be formed using integrated hardware or a plurality of separate pieces of hardware.

The communication I/F 16 communicably connects to the control apparatus 20 by, for example, establishment of a communication link between the control apparatus 20 and itself according to the control by the processing circuit 14. The communication I/F 16 may include, for example, an antenna that transmits and receives a signal, a circuit that processes the signal transmitted in the communication link, and a receptable into which a plug of a communication cable is inserted. The communication I/F 16 transmits a program created in the program creation supporting apparatus 10 to the control apparatus 20. The communication I/F 16 may include a receptable into which a plug of an auxiliary storage device for storing the program created in the program creation supporting apparatus 10 is inserted.

For example, the processing circuit 14 executes the program creation supporting program and displays a creation window for creation of a program for the robot 30 to perform work on the display device 11. For example, the processing circuit 14 determines work to be performed by the robot 30 according to the operation on the input device 12 by the user and displays an image showing a sequence of motion in the work on the display device 11. The image showing the sequence of motion includes, for example, motion objects as blocks showing various kinds of motion. Thereby, the sequence of motion to be performed by the robot 30 is presented to the user.

The motion object is selected according to the operation on the input device 12 by the user, and thereby, the parameter becomes changeable. Regarding the parameter in force control of each motion, a default value is set with respect to each motion object in advance and stored in the memory device 15. The target force in the force control is determined by the parameter of each motion.

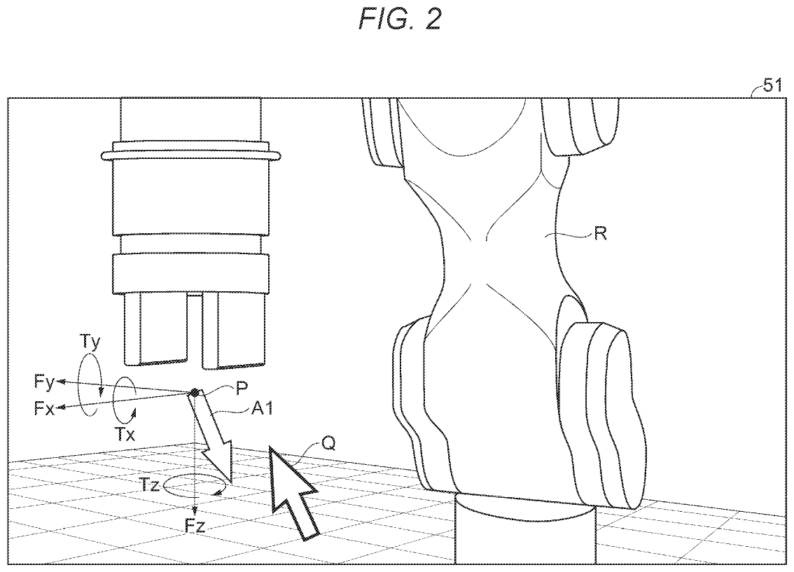

As shown in FIG. 2, for example, when one motion object is selected, the display device 11 displays a simulation window 51 containing a mark A1 having an aspect of showing the target force. The mark A1 is, for example, an arrow. When the mark A1 is an arrow, as the aspect of the mark A1, for example, at least one kind of aspect of a direction, a length, and a thickness of the arrow can be employed. In the example shown in FIG. 2, the direction of the arrow of the mark A1 indicates the direction of the target force. For example, the mark A1 is displayed to point the direction of the target force from a reference point P. For example, the reference point P is defined relatively to the TCP in a robot image R. The length or the thickness of the arrow of the mark A1 shows magnitude of the target force.

In the simulation window 51, the mark A1 is displayed as an image in a virtual three-dimensional space with the robot image R showing the robot 30. The robot image R may show a pose corresponding to an initial position of each motion. Further, in the example shown in FIG. 2, the simulation window 51 contains a plurality of arrows representing the respective components of the target force with respect to the reference point P. The plurality of arrows indicate directions of a force Fx parallel to an x-axis, a force Fy parallel to a y-axis, a force Fz parallel to a z-axis, torque Tx around the x-axis, torque Ty around the y-axis, and torque Tz around the z-axis. The coordinate system expressed by xyz is, for example, a base coordinate system. The coordinate system may be changed according to the type of work and the operation by the user from another coordinate system such as a world coordinate system or a mechanical interface coordinate system. Further, the simulation window 51 contains an installation surface of the robot 30 formed by a plurality of grid lines parallel to the x-axis and the y-axis.

The processing circuit 14 changes the aspect of the mark A1 according to the operation on the input device 12 by the user. The processing circuit 14 changes the target force in the force control for each motion of the robot 30 in correspondence with the aspect of the mark A1. Thereby, the processing circuit 14 calculates the parameter in the force control corresponding to the aspect of the mark A1. For example, the parameter in the force control includes at least one kind of parameter of the direction of the target force, the magnitude of the target force, and a parameter of mechanical impedance.

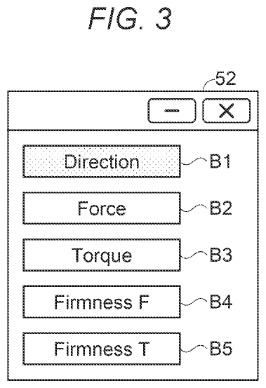

As shown in FIG. 3, for example, a creation window displayed on the display device 11 contains an adjustment panel 52 as a window for adjustment of the target force. The adjustment panel 52 contains, for example, five types of buttons B1 to B5. The button B1 is displayed as, for example, “Direction” and operated when the direction of the target force is adjusted. The button B2 is displayed as, for example, “Force” and operated when the magnitude of the transitional force of the target force is adjusted. The button B3 is displayed as, for example, “Torque” and operated when the magnitude of the torque of the target force is adjusted.

The button B4 is displayed as, for example, “Firmness F” and operated when the parameter of the mechanical impedance of the transitional force of the target force is adjusted. The button B5 is displayed as, for example, “Firmness T” and operated when the parameter of the mechanical impedance of the torque of the target force is adjusted. Note that the parameter of the mechanical impedance contains at least one of a virtual elastic coefficient, a virtual viscosity coefficient, and a virtual mass coefficient. Hereinafter, the parameter of the mechanical impedance is simply referred to as “impedance parameter”.

In the example shown in FIG. 3, the button B1 is operated, and thereby, the button B1 is highlighted and the processing circuit 14 enters a direction adjustment mode in which the direction of the target force is adjusted. In the direction adjustment mode, for example, the user adjusts the direction of the target force by operating the input device 12 such as a mouse. In the example shown in FIG. 2, a cursor Q as a pointer of the mouse is displayed on the simulation window 51. The cursor Q indicates a position in two-dimensional coordinates and it is difficult to directly designate the direction of the target force in a virtual three-dimensional space.

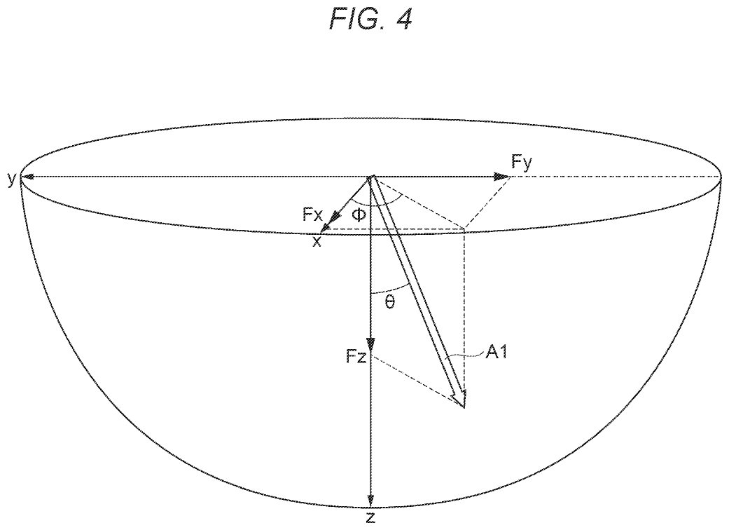

Accordingly, as shown in FIG. 4, the processing circuit 14 transforms the two-dimensional coordinates of the cursor Q into three-dimensional coordinates on a spherical surface, and thereby, calculates a direction of the mark A1 as the direction of the target force. Specifically, the two-dimensional coordinates of the cursor Q are defined by a vertical coordinate θ and a horizontal coordinate ϕ. In this case, x, y, and z as the three-dimensional coordinates of the cursor Q are calculated by the expressions (1) to (3). That is, in the example shown in FIG. 2, for example, the user moves the cursor Q on the simulation window 51 while pressing down the button of the mouse, and thereby, may adjust the direction of the mark A1 in the virtual three-dimensional space. The movement of the cursor Q may be realized by swipe of a touch panel, arrow keys of a keyboard, or the like.

$$\begin{matrix}x = r sin θ cos ϕ & ( 1 ) \\ y = r sin θsinϕ & ( 2 ) \\ z = r cos θ & ( 3 )\end{matrix}$$

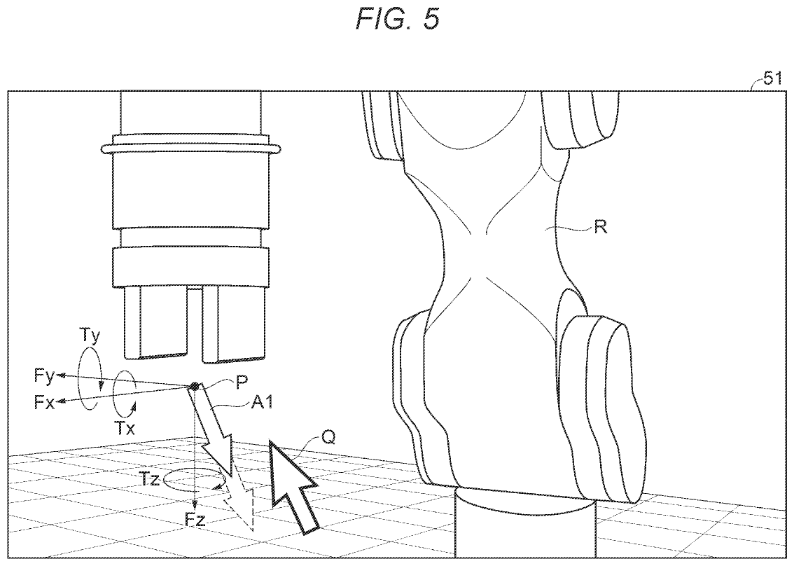

FIG. 5 shows an example of the simulation window in a force adjustment mode for adjustment of the magnitude of the translational force of the target force. The button B2 in FIG. 3 is operated, and thereby, the processing circuit 14 enters the force adjustment mode. For example, the user moves the cursor Q on the simulation window 51 while pressing down the button of the mouse, and thereby, may adjust the length of the mark A1 in the virtual three-dimensional space. In the example shown in FIG. 5, the length of the mark A1 shows the magnitude of the translational force of the target force. The thickness of the mark A1 may show the magnitude of the translational force. The movement of the cursor Q may be realized by swipe of a touch panel, arrow keys of a keyboard, or the like.

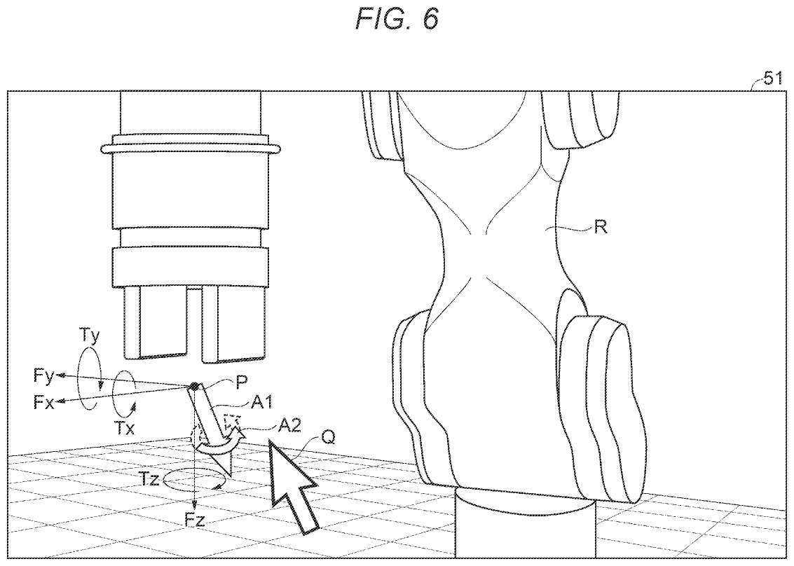

FIG. 6 shows an example of the simulation window in a torque adjustment mode for adjustment of the magnitude of the torque of the target force. The button B3 in FIG. 3 is operated, and thereby, the processing circuit 14 enters the torque adjustment mode. The simulation window of the torque adjustment mode contains a mark A2 displayed around the center axis of the mark A1. The mark A2 is an arrow indicating the rotation direction corresponding to the torque of the target force. For example, the mark A2 is displayed in the simulation window 51 with entry into the torque adjustment mode. The mark A2 may be displayed in the simulation window 51 constantly when the target force has a torque component.

In the torque adjustment mode, for example, the user moves the cursor Q on the simulation window 51 while pressing down the button of the mouse, and thereby, may adjust the length of the mark A2 in the virtual three-dimensional space. In the example shown in FIG. 6, the length of the mark A2 shows the magnitude of the torque of the target force. The movement of the cursor Q may be realized by swipe of a touch panel, arrow keys of a keyboard, or the like.

Or, the magnitude of the translational force and the magnitude of the torque of the target force can be adjusted at the same time. For example, the processing circuit 14 displays the mark A1 and the mark A2 in the simulation window 51. The length of the mark A1 and the magnitude of the translational force may be adjusted by vertical movement of the cursor Q, and the length of the mark A2 and the magnitude of the torque may be adjusted by horizontal movement of the cursor Q.

In addition, the button B4 in FIG. 3 is operated, and thereby, the processing circuit 14 enters a force impedance parameter adjustment mode for adjustment of the impedance parameter of the translational force of the target force. Further, the button B5 in FIG. 3 is operated, and thereby, the processing circuit 14 enters a torque impedance parameter adjustment mode for adjustment of the impedance parameter of the torque of the target force.

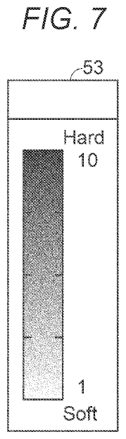

As shown in FIG. 7, when entering the force impedance parameter adjustment mode or the torque impedance parameter adjustment mode, the processing circuit 14 displays a color bar 53 presenting a color showing “hardness” on the display device 11. In the example shown in FIG. 7, regarding the hardness determined by the impedance parameter, “Soft” is displayed with a value of the softest case as “1” and “Hard” is displayed with a value of the hardest case as “10”. The color showing the hardness is lightest when the value is “1” and darkest when the value is “10”. The color showing the hardness gradually differs depending on the hardness. In practice, the color showing the hardness may be a warm color when the value indicating the hardness is smaller and may be a cool color when the value indicating the hardness is larger, for example, red when the value is “1” and blue when the value is “10”. The gradient of the color may be determined by various color spaces.

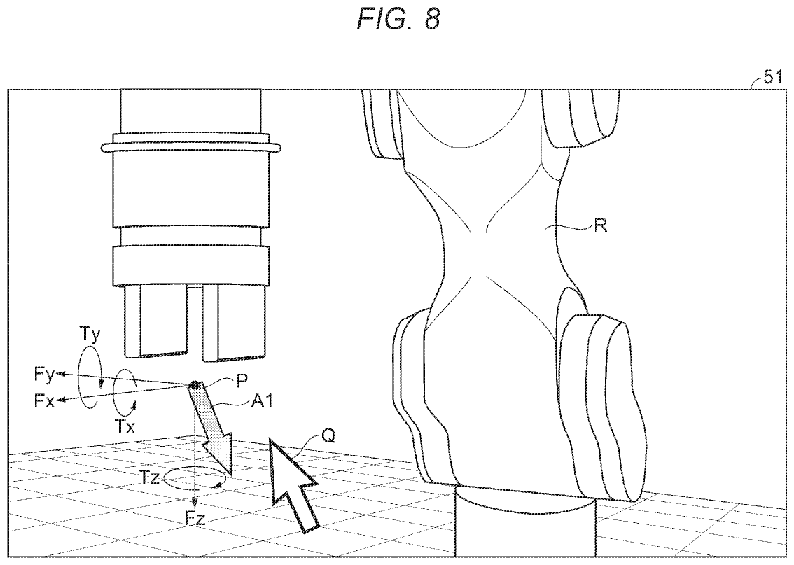

FIG. 8 shows an example of the simulation window 51 in a force impedance parameter adjustment mode. In the force impedance parameter adjustment mode, for example, the user moves the cursor Q on the simulation window 51 in the vertical directions while pressing down the button of the mouse, and thereby, may adjust the color of the mark A1. The processing circuit 14 changes the color of the mark A1 as an aspect of the mark A1. The parameter in the force control corresponding to the color of the mark A1 is an impedance parameter of the translational force. That is, the color of the mark A1 is adjusted, and thereby, the impedance parameter of the translational force of the target force may be determined.

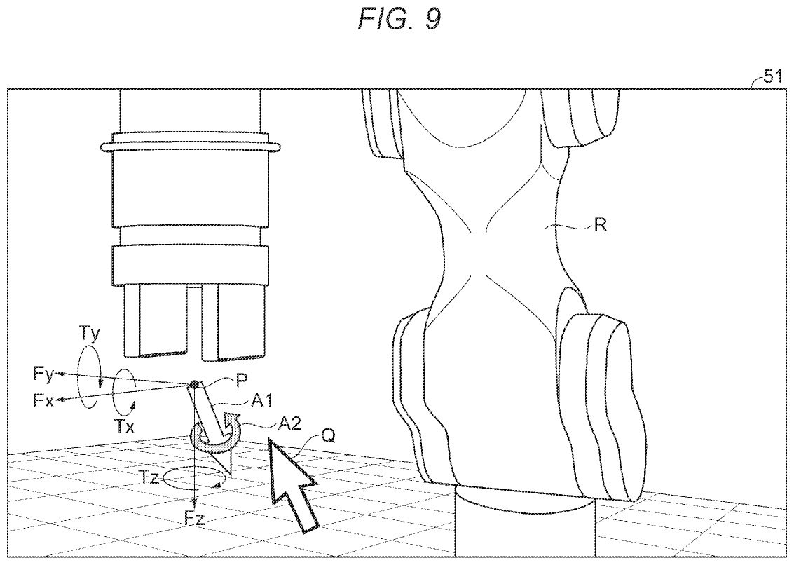

FIG. 9 shows an example of the simulation window 51 in a torque impedance parameter adjustment mode. The simulation window 51 of the torque impedance parameter adjustment mode contains the mark A2 displayed around the center axis of the mark A1. For example, the user moves the cursor Q on the simulation window 51 in the horizontal directions while pressing down the button of the mouse, and thereby, may adjust the color of the mark A2. The processing circuit 14 changes the color of the mark A2 as an aspect of the mark A2. The parameter in the force control corresponding to the color of the mark A2 is an impedance parameter of the torque. That is, the color of the mark A2 is adjusted, and thereby, the impedance parameter of the torque of the target force may be determined. The impedance parameters of the translational force and the torque of the target force can be adjusted at the same time.

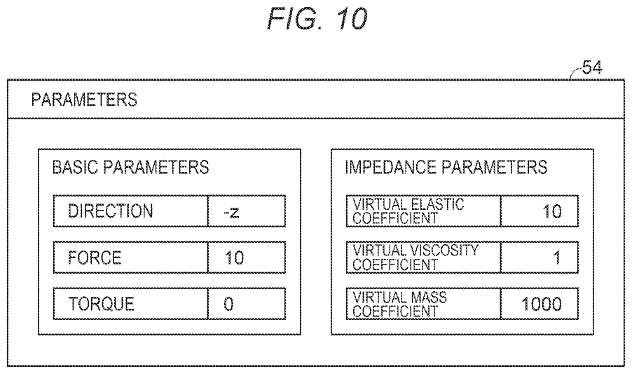

As shown in FIG. 10, the processing circuit 14 displays a parameter window 54 on the display device 11, and thereby, presents the respective parameters in the force control corresponding to the aspects of the mark A1 and the mark A2 to the user. The parameter window 54 contains at least one kind of parameter of the direction of the target force, the magnitude of the target force, and the impedance parameter. The magnitude of the target force is at least one of the magnitude of the translational force and the magnitude of the torque. The respective parameters displayed in the parameter window 54 may be set in a task program according to the operation on the input device 12 by the user.

Note that the aspects of the mark A1 and the mark A2 may be changed by changing of the respective parameters in the parameter window 54. That is, the respective parameters in the parameter window 54 and the aspects of the mark A1 and the mark A2 affect each other.

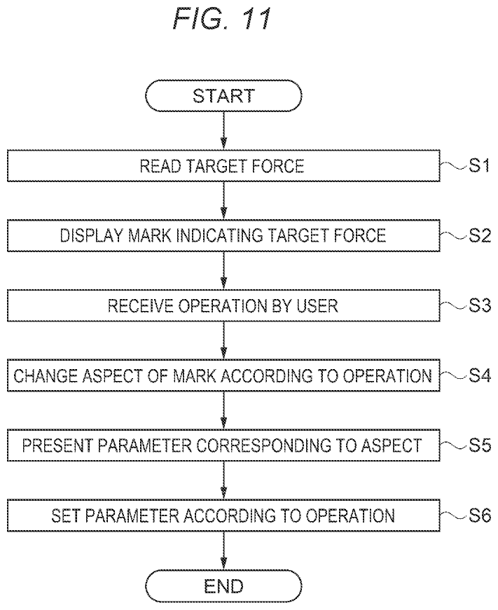

Referring to FIG. 11, an example of an operation of the program creation supporting apparatus 10 will be explained as a method for supporting creation of a program according to the embodiment. The series of processing including the processing shown in FIG. 11 is executed by a program creation supporting program installed in the control circuit 13.

At step S1, the processing circuit 14 determines a motion object according to the operation on the input device 12 by the user and reads a target force in force control corresponding to the motion object from the memory device 15.

At step S2, the processing circuit 14 displays a mark A having an aspect indicating the target force read at step S1 on the simulation window 51. The mark A is one of the mark A1 and the mark A2.

At step S3, the processing circuit 14 receives an operation on the input device 12 by the user. At step S4, the processing circuit 14 changes the aspect of the mark A according to the operation detected at step S3.

At step S5, the processing circuit 14 calculates a parameter in force control corresponding to the aspect of the mark A changed at step S4. The display device 11 displays the parameter window 54 containing the calculated parameter. At step S6, the processing circuit 14 sets the parameter displayed in the parameter window 54 as a parameter in the task program according to the operation on the input device 12 by the user.

According to the program creation supporting apparatus 10, the mark A having the aspect indicating the target force is displayed, and the user may intuitively grasp a change of the target force. Further, the program creation supporting apparatus 10 presents the parameter in the force control corresponding to the aspect of the mark A, and the user may easily grasp a relationship between the target force and the parameter in the force control.

Furthermore, the program creation supporting apparatus 10 shows the parameter in the force control, which is difficult to grasp by a numerical value, by the aspect of the mark A such as a direction, a length, or a color, and the user may intuitively grasp the parameter in the force control. In addition, the presented parameter may be set in the task program, and creation of the task program may be simplified.

The embodiment is explained as above, however, the present disclosure is not limited to these disclosures. The configurations of the respective parts may be replaced by arbitrary configurations having the same functions, or arbitrary configurations in the respective embodiments may be omitted or added within the technical scope of the present disclosure. From these disclosures, various alternative embodiments would be clear to a person skilled in the art.

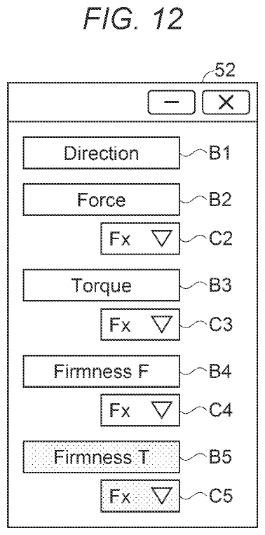

For example, as shown in FIG. 12, the processing circuit 14 may display the adjustment panel 52 containing list boxes C2 to C5 for specification of components of a target force to be adjusted on the display device 11. For example, the respective list boxes C2 to C5 display lists of the components of the target force including Fx, Fy, Fz, Tx, Ty, and Tz as options presented to the user according to the use operation. For example, the processing circuit 14 specifies the component of Fx from the list box C5 as an object to be adjusted according to the operation on the input device 12 by the user. In this case, the color of the mark A2 corresponding to the component of Fx may be selectively changed in the torque impedance parameter adjustment mode.

In the simulation window 51, colors of a plurality of arrows may be changed according to whether or not components of the target force used in the force control is enabled. For example, in the example shown in FIG. 2, when the component of Fx is selectively disabled, only the component of Fx may be displayed in gray and the other components may be displayed in the other colors. Further, the mark A1 may be resolved to a plurality of arrows of components of Fx, Fy, and Fz and lengths of the corresponding components may be adjusted by operation on the resolved arrows. Furthermore, list boxes of the impedance parameters for selection of the virtual elastic coefficient, the virtual viscosity coefficient, and the virtual mass coefficient may be displayed respectively adjacent to the button B4 and the button B5, and the color bar 53 may be displayed with respect to each impedance parameter.

The present disclosure obviously includes other various embodiments such as configurations in which the above described respective configurations are mutually applied, not described as above. The technical scope of the present disclosure is defined only by the matters used to specify the invention according to the appended claims appropriate from the above description.

What is claimed is:

1. A method for supporting creation of a program for supporting creation of a program for a robot that performs work on an object by force control for controlling a force acting on the object to be a target force, the method comprising:
displaying a mark having an aspect indicating the target force on a display device;
changing the aspect of the mark according to an operation on an input device by a user; and
presenting a parameter in the force control corresponding to the aspect of the mark to the user.

2. The method for supporting creation of the program according to claim 1, wherein
the mark is an arrow.

3. The method for supporting creation of the program according to claim 2, wherein
at least one of a direction, a length, and a thickness of the arrow is changed as the aspect of the mark.

4. The method for supporting creation of the program according to claim 1, wherein
the parameter is set in the program.

5. The method for supporting creation of the program according to claim 1, wherein
at least one of a direction of the target force, magnitude of the target force, and a parameter of mechanical impedance is presented as the parameter in the force control.

6. The method for supporting creation of the program according to claim 1, wherein
the aspect of the mark corresponding to a specific component of the target force is selectively changed.

7. The method for supporting creation of the program according to claim 1, wherein
a color of the mark is changed as the aspect of the mark, and
the parameter in the force control corresponding to the color of the mark is a parameter of mechanical impedance.

8. A program creation supporting apparatus supporting creation of a program for a robot that performs work on an object by force control for controlling a force acting on the object to be a target force, the apparatus comprising:
a display device displaying a mark having an aspect indicating the target force;
an input device detecting an operation by a user; and
a control circuit changing the aspect of the mark according to the operation, and presenting a parameter in the force control corresponding to the aspect of the mark to the user.

9. A non-transitory computer-readable storage medium storing a program creation supporting program for supporting creation of a program for a robot that performs work on an object by force control controlling a force acting on the object to be a target force, the program controlling a computer to execute processing comprising:
displaying a mark having an aspect indicating the target force on a display device;
changing the aspect of the mark according to an operation on an input device by a user; and
presenting a parameter in the force control corresponding to the aspect of the mark to the user.
